(19) United States
(12) Patent Application Publication
(10) Pub. No.: US 2026/0065763 A1
(43) Pub. Date: Mar. 5, 2026

(54) DEVICE AND METHOD FOR MONITORING TEMPERATURES IN OR AROUND A HAZARD DETECTION DEVICE TO DETECT AN ALERT CONDITION

(71) Applicant: Microchip Technology Incorporated, Chandler, AZ (US)

(72) Inventors: Arthur B. Eck, Gilbert, AZ (US); Patrick McFarland, Gilbert, AZ (US)

(73) Assignee: Microchip Technology Incorporated, Chandler, AZ (US)

(21) Appl. No.: 18/947,241

(22) Filed: Nov. 14, 2024

Related U.S. Application Data
(60) Provisional application No. 63/688,902, filed on Aug. 30, 2024.

(51) Int. Cl. G08B 17/06; G01K 3/10; G01K 3/14

(52) U.S. Cl. CPC G08B 17/06; G01K 3/10; G01K 3/14; G01K 2207/00

(57) ABSTRACT

A hazard detection device includes a housing structure separating a first space from a second space, and including housing structure aperture(s) allowing airflow between the first space and second space. A first temperature sensor device is arranged in the first space to generate first sensor data indicating a first space temperature in the first space, and a second temperature sensor device is arranged in the second space to generate second sensor data indicating a second space temperature in the second space. The hazard detection device includes control circuitry to receive the first sensor data from the first temperature sensor device and the second sensor data from the second temperature sensor device, monitor a temperature difference between the first space temperature indicated by the first sensor data and second space temperature indicated by the second sensor data, identify an alert condition based on the monitored temperature, and output an alert notification.

### RELATED APPLICATION

This application claims priority to commonly owned U.S. Provisional Patent Application No. 63/688,902 filed Aug. 30, 2024, the entire contents of which are hereby incorporated by reference for all purposes.

### TECHNICAL FIELD

The present disclosure relates to devices and method for monitoring temperatures in or around a hazard detection device (e.g., a smoke, fire, or carbon monoxide detector) to detect an alert condition, e.g., an airflow blockage.

### BACKGROUND

A typical smoke detector, e.g., an optical smoke detector, includes a photo chamber typically mounted on a PCB and arranged under a protective cover. The protective cover and the photo chamber arranged under the cover includes respective inlet openings allowing air to flow into the photo chamber for detection of smoke. The photo chamber typically includes a radiation source (e.g., infrared LED) and a radiation sensor (e.g., photo diode), wherein the presence of smoke particles inside the photo chamber affects (e.g., increases) the amount of radiation received at the radiation sensor, e.g., due to reflection/scattering caused by the smoke particles. The photo chamber typically includes anti-reflective baffles to reduce the influence of extraneous light on the radiation sensor.

A problem can occur when the openings in the protective cover and/or openings to the photo chamber inside the protective cover become blocked, thus preventing smoke from flowing from the external environment into the photo chamber to be detected. For example, inlet apertures of the photo chamber (e.g., gaps between adjacent anti-reflective baffles) may become blocked with dust and debris over time, preventing air from entering the photo chamber. As another example, inlet openings in the protective cover may be blocked, for example by a person wanting to disable the detector. One attempt to address this problem involves arranging a series of flash LEDs surrounding the photo chamber and measuring light leakage to identify blocked openings. However, this approach is expensive in terms of cost of LEDs, devices to drive the LEDs, and power supply for such surge levels (e.g., each LED typically requires hundreds of milliamperes.)

There is a need for improved (e.g., low cost and low energy) systems and methods for determining an airflow blockage in a smoke detector, carbon monoxide detector, or other hazard detection device.

### SUMMARY

The present disclosure provides devices and methods for determining an alert condition in a hazard detection device, e.g., in a smoke, fire, or carbon monoxide detector, by monitoring temperatures as different locations relative to the device. For example, a hazard detection device and method may be provided to detect an airflow blockage in the device, for example resulting from a blockage (full or partial) of aperture(s) provided in a housing structure of the device for allowing airflow into or out of the device. Such blockages may include dust, debris, spider webs, tape, paper, or any other type of obstruction. As these airflow blockages may affect (e.g., slow) the rate of heat transfer through the housing structure aperture(s), disclosed devices and methods may detect an airflow blockage (or other defined alert condition) by monitoring a temperature difference across the aperture(s), e.g., a difference in temperature between measured spaces on opposite sides of the housing structure, and analyzing such temperature difference over time.

In some examples, a hazard detection device (e.g., a smoke, fire, or carbon monoxide detector) includes (a) a first temperature sensor arranged outside a housing structure of the hazard detection device (e.g., an outer cover or an inner housing, e.g., a housing of a photo chamber) to measure a first temperature outside the housing structure, (b) a second temperature sensor arranged inside housing structure to measure a second temperature inside the housing structure, and (c) control circuitry to receive measurement data from the first and second temperature sensors and monitor a temperature difference (temperature delta) between the first and second temperatures to detect an alert condition, for example indicating a blockage or obstruction of aperture(s) in the housing structure inhibiting proper airflow through the device. The first and second temperature sensors may comprise a pair of low thermal mass thermocouples, silicon temperature sensors, or anti-parallel diodes (e.g., PN junction transistors), for example.

In some examples, the control circuitry may detect an air flow blockage by analyzing the temperature difference (temperature delta) between the first and second temperature sensors over time, using any suitable rules or algorithms. In the event of a blockage, temperature changes in the space outside the relevant housing structure will take longer to propagate to an area inside the housing structure, such that the first and second temperature sensors may experience larger temperature differences and longer durations to reach equilibrium between the temperature sensors after a change in one temperature.

Accordingly, the control circuitry may detect a blockage based on the magnitude of the temperature delta, a duration of a temperature delta, or a rate of change of the temperature delta over time, wherein any of such measures may be compared to respective threshold values corresponding with a blockage. In some examples, such threshold values can be established by testing un unblocked detector. Measuring temperature requires very little energy, which may be particularly advantageous for smoke detectors under stringent low energy requirements.

One aspect provides a hazard detection device including a housing structure, temperature sense circuitry, and control circuitry. The housing structure separates a first space from a second space, and includes at least one housing structure aperture allowing airflow between the first space and the second space. The temperature sense circuitry includes a first temperature sensor device arranged in the first space to generate first sensor data indicating a first space temperature in the first space, and a second temperature sensor device arranged in the second space to generate second sensor data indicating a second space temperature in the second space. The control circuitry is connected to the temperature sense circuitry, and includes circuitry to receive the first sensor data from the first temperature sensor device and the second sensor data from the second temperature sensor device, monitor a temperature difference between the first space temperature indicated by the first sensor data and the second space temperature indicated by the second sensor data, identify an alert condition based on the monitored temperature difference between the first space temperature and the second space temperature, and output an alert notification in response to identifying the alert condition.

In some examples, the control circuitry to identify the alert condition comprises the control circuitry to identify a blockage of the at least one housing structure aperture based on the monitored temperature difference between the first space temperature and the second space temperature.

In some examples, the hazard detection device includes an inner housing comprising the housing structure, wherein the at least one housing structure aperture comprises at least one aperture in the inner housing, an inner chamber inside the inner housing, an outer housing at least partially covering the inner housing, and an outer chamber between the inner housing and the outer housing. The first temperature sensor device is arranged outside the outer housing, wherein the first space temperature indicated by the first sensor data is a temperature of an external environment outside the outer housing, and the second temperature sensor device is arranged in the inner chamber, wherein the second space temperature indicated by the second sensor data is a temperature in the inner chamber.

In some examples, the inner chamber comprises a hazard detection chamber including hazard detection electronics for detecting at least one of smoke or fire.

In some examples, the hazard detection device includes an inner housing comprising the housing structure, wherein the at least one housing structure aperture comprises at least one aperture in the inner housing, an inner chamber inside the inner housing, an outer housing at least partially covering the inner housing, and an outer chamber between the inner housing and the outer housing. The first temperature sensor device is arranged in the outer chamber, wherein the first space temperature indicated by the first sensor data is a temperature in the outer chamber, and the second temperature sensor device is arranged in the inner chamber, wherein the second space temperature indicated by the second sensor data is a temperature in the inner chamber.

In some examples, the hazard detection device includes an inner housing, an inner chamber inside the inner housing, an outer housing at least partially covering the inner housing, the outer housing comprising the housing structure, wherein the at least one housing structure aperture comprises at least one aperture in the outer housing, and an outer chamber between the inner housing and the outer housing. The first temperature sensor device is arranged outside the outer housing, wherein the first space temperature indicated by the first sensor data is a temperature of an external environment outside the outer housing, and the second temperature sensor device is arranged in the outer chamber, wherein the second space temperature indicated by the second sensor data is a temperature in the outer chamber.

In some examples, the hazard detection device includes an inner housing, an inner chamber inside the inner housing, an outer housing at least partially covering the inner housing, the outer housing comprising the housing structure, wherein the at least one housing structure aperture comprises at least one aperture in the outer housing, and an outer chamber between the inner housing and the outer housing. The first temperature sensor device is arranged outside the outer housing, wherein the first space temperature indicated by the first sensor data is a temperature of an external environment outside the outer housing, and the second temperature sensor device is arranged in the inner chamber, wherein the second space temperature indicated by the second sensor data is a temperature in the inner chamber.

In some examples, the hazard detection device includes an inner housing, an inner chamber inside the inner housing, an outer housing at least partially covering the inner housing, and an outer chamber between the inner housing and the outer housing. The first temperature sensor device is arranged outside the outer housing to generate first sensor data indicating a first space temperature of an external environment outside the outer housing, and the second temperature sensor device is arranged in the outer chamber to generate second sensor data indicating a second space temperature in the outer chamber. In addition, a third temperature sensor device is arranged in the inner chamber to generate third sensor data indicating a third space temperature in the inner chamber. The control circuitry comprises circuitry to monitor the temperature difference between the first space temperature indicated by the first sensor data and the second space temperature indicated by the second sensor data, monitor a further temperature difference between the second space temperature indicated by the second sensor data and the third space temperature indicated by the third sensor data, and identify an alert condition based on at least one of the monitored temperature difference or the monitored further temperature difference.

In some examples, the control circuitry to identify an alert condition based on the monitored temperature difference between the first space temperature and the second space temperature comprises control circuitry to compare the temperature difference between the first space temperature and the second space temperature to a temperature difference threshold value, and determine an alert condition if the temperature difference exceeds the temperature difference threshold value.

In some examples, the control circuitry includes circuitry to compare the temperature difference between the first space temperature and the second space temperature to a temperature difference threshold value, and determine an alert condition if the temperature difference exceeds the temperature difference threshold value for a defined duration of time.

In some examples, the control circuitry includes circuitry to determine a rate of change of the temperature difference between the first space temperature and the second space temperature, and determine an alert condition based on the determined rate of change of the temperature difference between the first space temperature and the second space temperature.

In some examples, determining the alert condition based on the determined rate of change of the temperature difference between the first space temperature and the second space temperature comprises determining the alert condition if the determined rate of change of the temperature difference between the first space temperature and the second space temperature is less than a temperature difference rate-of-change threshold value.

One aspect provides a method including operating a first temperature sensor device arranged in a first space associated with a hazard detection device to generate first sensor data indicating a first space temperature in the first space; operating a second temperature sensor device arranged in the second space associated with the hazard detection device to generate second sensor data indicating a second space temperature in the second space; wherein the first space and second space are separated by a housing structure of the hazard detection device, the housing structure including at least one housing structure aperture allowing airflow between the first space and the second space; receiving, at control circuitry connected to the first and second temperature sensors, the first sensor data from the first temperature sensor device and the second sensor data from the second temperature sensor device; monitoring, by the control circuitry, a temperature difference between the first space temperature indicated by the first sensor data and the second space temperature indicated by the second sensor data; identifying, by the control circuitry, an alert condition based on the monitored temperature difference between the first space temperature and the second space temperature; and outputting, by the control circuitry, an alert notification in response to identifying the alert condition.

In some examples, the housing structure comprises a structure of an inner housing of the hazard detection device, the first temperature sensor device is arranged in an outer chamber between the inner housing and an outer housing of the hazard detection device, wherein the first space temperature indicated by the first sensor data is a temperature in the outer chamber, and the second temperature sensor device is arranged in an inner chamber inside the inner housing, wherein the second space temperature indicated by the second sensor data is a temperature in the inner chamber.

In some examples, the housing structure comprises a structure of an outer housing of the hazard detection device, the first temperature sensor device is arranged outside the outer housing, wherein the first space temperature indicated by the first sensor data is a temperature of an external environment outside the outer housing, and the second temperature sensor device is arranged inside the outer housing, wherein the second space temperature indicated by the second sensor data is a temperature inside the outer housing.

In some examples, identifying the alert condition comprises identifying a blockage of the at least one housing structure aperture based on the monitored temperature difference between the first space temperature and the second space temperature.

In some examples, identifying the alert condition comprises comparing the temperature difference between the first space temperature and the second space temperature to a temperature difference threshold value, and identifying the alert condition if the temperature difference exceeds the temperature difference threshold value.

In some examples, identifying an alert condition comprises comparing the temperature difference between the first space temperature and the second space temperature to a temperature difference threshold value, and identifying an alert condition if the temperature difference exceeds the temperature difference threshold value for a defined duration of time.

In some examples, identifying the alert condition comprises determining a rate of change of the temperature difference between the first space temperature and the second space temperature, and identifying the alert condition based on the determined rate of change of the temperature difference between the first space temperature and the second space temperature.

One aspect provides a system including a processor and logic instructions stored in non-transitory memory and executable by the processor to receive first sensor data from a first temperature sensor device arranged in a first space associated with a hazard detection device, the first sensor data indicating a first space temperature in the first space; receive second sensor data from a second temperature sensor device arranged in a second space associated with the hazard detection device, the second sensor data indicating a second space temperature in the second space; wherein the first space and second space are separated by a housing structure of the hazard detection device, the housing structure including at least one housing structure aperture allowing airflow between the first space and the second space; monitor a temperature difference between the first space temperature indicated by the first sensor data and the second space temperature indicated by the second sensor data; identify an alert condition based on the monitored temperature difference between the first space temperature and the second space temperature; and output an alert notification in response to identifying the alert condition.

### BRIEF DESCRIPTION OF THE DRAWINGS

Example aspects of the present disclosure are described below in conjunction with the figures, in which:

FIG. 1 shows an example hazard detection device (e.g., a smoke detector or CO detector) configured to monitor temperature differences at different locations to detect an alert condition, for example an airflow blockage;

FIG. 2 is a cross-sectional side view of an example hazard detection device implementing a first example arrangement of first and second temperature sensor devices for detecting an alert condition;

FIG. 3 is a cross-sectional side view of an example hazard detection device implementing a second example arrangement of first and second temperature sensor devices for detecting an alert condition;

FIG. 4 is a cross-sectional side view of an example hazard detection device implementing a third example arrangement of first and second temperature sensor devices for detecting an alert condition;

FIG. 5 is a cross-sectional side view of an example hazard detection device implementing a fourth example arrangement of first and second temperature sensor devices for detecting an alert condition;

FIGS. 6A and 6B show an example hazard detection device including a photo detection chamber for optical detection of smoke;

FIG. 7 shows example temperature sense circuitry including a pair of temperature sensor devices embodied as anti-parallel diodes;

FIG. 8 shows example temperature sense circuitry including a pair of temperature sensor devices embodied as a pair of silicon temperature sensors;

FIG. 9 shows example temperature sense including a pair of temperature sensor devices embodied as a pair of thermocouples; and

FIG. 10 is a flowchart showing a method for identifying an alert condition, e.g., a blocked airflow path, in a hazard detection device by monitoring a temperature difference at different locations.

It should be understood that the reference number for any illustrated element that appears in multiple different figures has the same meaning across the multiple figures, and the mention or discussion herein of any illustrated element in the context of any particular figure also applies to each other figure, if any, in which that same illustrated element is shown.

### DETAILED DESCRIPTION

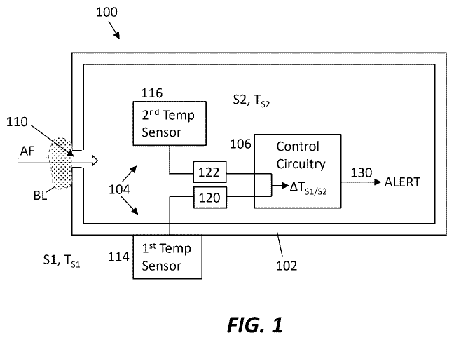

FIG. 1 shows an example hazard detection device 100 (e.g., a smoke, fire, and/or CO detector) configured to monitor temperature differences at different locations to detect an alert condition, for example indicating an airflow blockage that may affect the functioning of the hazard detection device 100. As shown, the hazard detection device 100 may include a housing structure 102, temperature sense circuitry 104, and control circuitry 106 connected to the temperature sense circuitry 104. The housing structure 102 separates a first space S1 from a second space S2, and includes at least one housing structure aperture 110 allowing airflow AF between the first space S1 and the second space S2. In some examples, the housing structure 102 may comprise an outer cover of the hazard detection device 100, wherein the first space S1 is an external environment outside the outer housing, and the second space S2 is inside the outer cover.

In some examples, the housing structure 102 may comprise an inner housing of the hazard detection device 100, i.e., a housing arranged inside an outer cover, for example a cover or housing of a hazard detection chamber arranged inside the outer cover of the hazard detection device 100. In such examples, the first space S1 may correspond with an external environment outside the outer housing, or a space between the outer cover and inner housing, and the second space S2 is inside the inner housing.

The at least one housing structure aperture 110 may comprise one or more hole, slot, grill, or other opening(s) that allow airflow AF between the first space S1 and the second space S2 at least one direction, e.g., from the first space S1 into the second space S2 and/or second space S2 into the first space S1. As used herein, airflow refers to a flow of air that may (or may not) include hazardous gasses or substances, for example, smoke, carbon monoxide, and/or other gasses or substances.

Temperature sense circuitry 104 may include multiple temperature sensor devices arranged to monitor temperature data at different locations, which temperature data may be analyzed by control circuitry 106 to detect an alert condition, as discussed below. In the example shown in FIG. 1, temperature sense circuitry 104 includes at least (a) a first temperature sensor device 114 arranged in the first space S1 outside the housing structure 102 to output first sensor data 120 indicating a first space temperature T_{S1} in the first space S1, and (b) a second temperature sensor device 116 arranged in the second space S2 to output second sensor data 122 indicating a second space temperature T_{S2} in the second space S2.

The first and second temperature sensor devices 114 and 116 may comprise any type or types of temperature sensors, for example, thermocouples, diode, or silicon temperature sensors that generate sensor signals, e.g., voltages or other signals, corresponding with measured temperatures. In some examples, the first and second temperature sensor device 114 and 116 may include sensor circuitry to generate sensor signals (e.g., voltages or other signals) and processing circuitry to convert other otherwise process the sensor signals, for example an ADC to convert analog sensor signals to digital signals, or a differential driver to measure a temperature differential between different sensors of the first and second temperature sensor devices 114 and 116. Thus, first sensor data 120 and second sensor data 122 output by first and second temperature sensor devices 114 and 116 (and communicated to control circuitry) may comprise raw or processed sensor signals, and may be embodied as analog or digital signals.

Control circuitry 106 may include circuitry to monitor a temperature difference ΔT_{S1/S2} between the first space S1 and second space S2 based on first and second sensor data 120 and 122 from first and second temperature sensor devices 114 and 116, respectively, to detect an alert condition based on the monitored temperature difference. The temperature difference ΔT_{S1/S2} may be expressed as an absolute difference or as a percentage difference, for example. Control circuitry 106 may include any suitable circuitry to monitor and analyze the temperature difference ΔT_{S1/S2}, for example, a comparator, a processor, logic instructions embodied as software or firmware stored in memory and executable the processor, and/or any other suitable circuitry.

In some examples, control circuitry 106 may include circuitry to detect an alert condition indicating a blockage of airflow AF through at least one housing structure aperture 110 separating the first space S1 from the second space S2. As used herein, a blockage of a respective aperture refers to a partial or full blockage of airflow through the respective aperture, e.g., resulting from dust, a spider web or other animal-created blockage, or a physical object (e.g., tape, paper, or other object) place over or in the aperture. The airflow blockage may reduce or slow the transfer of heat between the first space S1 from the second space S2, which reduced/slowed heat transfer may be detected by control circuitry 106 by monitoring the temperature difference ΔT_{S1/S2} between the first space S1 and second space S2.

Thus, in some examples, control circuitry 106 may include circuitry to (a) receive first sensor data 120 (indicating a first space temperature T_{S1} in the first space S1) from first temperature sensor device 114 and second sensor data 122 (indicating a second space temperature T_{S2} in the second space S2) from second temperature sensor device 116; (b) monitor a temperature difference ΔT_{S1/S2} between the first space temperature T_{S1} indicated by the first sensor data 120 and the second space temperature T_{S2} indicated by the second sensor data 122; (c) identify an alert condition (e.g., indicating a blockage of airflow AF through housing structure aperture(s) 110) based on the monitored temperature difference ΔT_{S1/S2}; and (d) output an alert notification 130 in response to identifying the alert condition.

In some examples, control circuitry 106 may compare the monitored temperature difference ΔT_{S1/S2} to at least one temperature difference threshold value, and determine an alert condition based on such comparison(s). For example, control circuitry 106 may determine an alert condition if the temperature difference ΔT_{S1/S2} exceeds a defined temperature difference threshold value. In some examples, control circuitry 106 may determine an alert condition if the temperature difference ΔT_{S1/S2} exceeds a defined temperature difference threshold value for a defined duration of time, for example to prevent false positive alerts based on erroneous transient sensor data.

As another example, control circuitry 106 may determine an alert condition based on a rate of change of the temperature difference ΔT_{S1/S2}. For example, control circuitry 106 may determine an alert condition if the rate of change of the temperature difference ΔT_{S1/S2} is less than a defined ΔT_{S1/S2} rate-of-change threshold value. In some examples, control circuitry 106 may determine an alert condition if the rate of change of the temperature difference ΔT_{S1/S2} is less than a defined ΔT_{S1/S2} rate-of-change threshold value for a defined duration of time, for example to prevent false positive alerts based on erroneous transient sensor data.

Control circuitry 106 may apply any suitable model or algorithms to analyze the temperature difference ΔT_{S1/S2} over time to determine the presence of an alert condition.

Such algorithms may include mathematical models of heat transfer, e.g., accounting for convection, conduction, radiation, flow and/or mass transport. For example, control circuitry 106 may utilize a convection heat transfer model describing the process of heat transfer through the movement of a fluid described by a heat transfer rate (Q) to the temperature difference between a surface and the fluid, using a convection heat transfer coefficient (h) and the surface area (A), wherein Q=h*A*(T_{surface}−T_{fluid}), e.g., to model expected temperature changes, deltas and rate of change, and compare measured data (e.g., ΔT_{S1/S2}) to such heat transfer model.

In addition, a heat transfer model implemented by control circuitry 106 may account for conduction, e.g., based on Fourier's Law. For example, for a heat flux q=Q/A, wherein Q is the heat flow rate through a solid with cross-sectional area A, Fourier's law states that heat flux is proportional to thermal gradient: q=−k dT/dx, where k represents thermal conductivity. The heat transfer model may account for conduction accordingly.

In addition, a heat transfer model implemented by control circuitry 106 may incorporate differential equations that govern mix rate and heat flow in a fluid, e.g., to model unblocked heat flow and determine expected temperature change behavior.

It should be understood that the models discussed above are examples only, and control circuitry 106 may apply any suitable model, algorithms and/or threshold values to analyze the temperature difference ΔT_{S1/S2} over time to determine the presence of an alert condition.

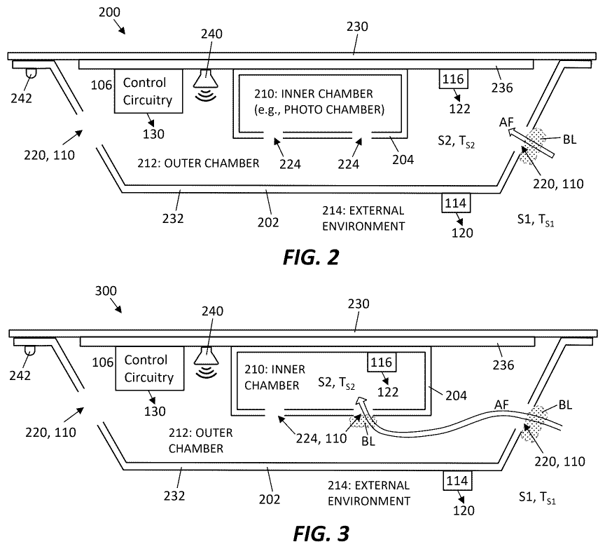

The arrangement of the first and second temperature sensor devices 114 and 116 relative to respective structures of the hazard detection device 100 to thereby define first and second spaces S1 and S2 monitored by the first and second temperature sensor devices 114 and 116, respectively, may be referred to as a “multi-sensor arrangement.” FIGS. 2-5 show example implementations of the hazard detection device 100 shown in FIG. 1 employing differing multi-sensor arrangements, using different arrangements of the temperature sensor devices 114 and 116 relative to respective structures of the hazard detection device 100 to measure respective temperatures at respective first and second spaces S1 and S2 defined by the respective arrangement of temperature sensor devices 114 and 116.

FIG. 2 is a cross-sectional side view of an example hazard detection device 200 (e.g., a smoke, fire, and/or CO detector) representing an example implementation of the hazard detection device 100 shown in FIG. 1 with a first example multi-sensor arrangement. The example hazard detection device 200 includes an inner housing 204 and an outer housing 202 at least partially covering the inner housing 204. The inner housing 204 defines an inner chamber 210, and the outer housing 202 defines (a) an outer chamber 212 between the inner housing 204 and outer housing 202 (i.e., an area inside the outer housing 202 and outside the inner housing 204) and (b) an external environment 214 outside the outer housing 202.

The outer housing 202 may include one or more outer housing aperture 220 connecting the external environment 214 with the outer chamber 212 (allowing airflow between the external environment 214 and outer chamber 212). Similarly, the inner housing 204 may include one or more inner housing aperture 224 connecting the outer chamber 212 with the inner chamber 210 (allowing airflow between the outer chamber 212 and inner chamber 210). Together, the outer housing aperture(s) 220 and inner housing aperture(s) 224 allow airflow between the external environment 214 and inner chamber 210.

In some examples, the outer housing 202 comprises a mounting base 230 and an outer cover 232 of the hazard detection device 200.

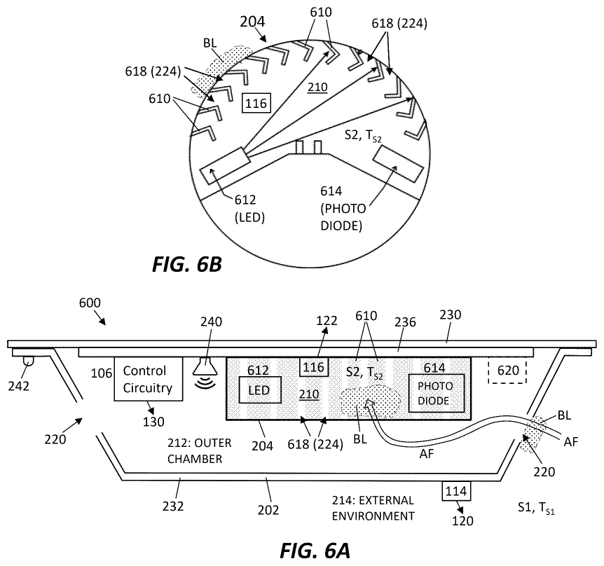

In some examples, the inner chamber 210 comprises a hazard detection chamber including hazard detection electronics for detecting at least one of smoke, fire, carbon monoxide, or other hazardous gas, compound, or environmental condition, and the inner housing 204 may comprise any structure(s) that at least partially defines the hazard detection chamber. For example, as discussed below regarding FIGS. 6A-6B, an in implementation in which the inner chamber 210 comprises a photo chamber for detecting smoke, the inner housing 204 may include anti-reflective baffles extending around a perimeter of the photo chamber, wherein gaps between adjacent baffles define inner housing apertures 224.

In some examples, the control circuitry 106, and in some examples hazard detection electronics for detecting a hazard in the inner chamber 210, may be mounted on a PCB 236.

As shown, the first temperature sensor device 114 is arranged outside the outer housing 202 to measure a first space temperate ΔT_{S1} in the external environment 214 (first space S1), and the second temperature sensor device 116 is arranged inside the outer housing 202 but outside the inner housing 204 to measure a second space temperature ΔT_{S2} in the outer chamber 212 (second space S2). For example, the first temperature sensor device 114 may be mounted on an exterior of the outer housing 202, and the second temperature sensor device 116 may be mounted on the PCB 236, on an exterior of the inner housing 204, or an interior of the outer housing 202.

As used herein, a temperature sensor device (e.g., temperature sensor device 114 or 116) “arranged in” a respective area (e.g., the inner chamber 210 or outer chamber 212) or “arranged inside” a respective structure (e.g., the inner housing 204 or outer housing 202) means the temperature sensor device is located and arranged in such a way to measure a temperature of air in the respective area or inside the respective structure. Thus, for example, a temperature sensor device “arranged inside” the inner housing 204 may be physically located within the inner housing 204, or may be physically located (fully or partially) outside the inner housing 204 but arranged to measure a temperature inside the inner housing 204 (i.e., a temperature in the inner chamber 210). For instance, a temperature sensor device may be mounted on an outer surface of the inner housing 204 but arranged to measure a temperature inside the inner housing 204 (i.e., temperature in the inner chamber 210) though an opening in the inner housing 204 providing an interface between the temperature sensor device and the inner chamber 210.

Similarly, a temperature sensor device (e.g., temperature sensor device 114 or 116) “arranged outside” a respective structure (e.g., the inner housing 204 or outer housing 202) means the temperature sensor device is located and arranged in such a way to measure a temperature of air outside the respective structure. Thus, for example, a temperature sensor device “arranged outside” the outer housing 202 may be physically located outside the outer housing 202, or may be physically located (fully or partially) inside the outer housing 202 but arranged to measure a temperature outside the outer housing 202 (i.e., a temperature of the external environment 214). For instance, a temperature sensor device may be mounted on an inner surface of the outer housing 202 but arranged to measure a temperature outside the outer housing 202 (i.e., temperature of the external environment 214) though an opening in the outer housing 20 providing an interface between the temperature sensor device and the external environment 214.

According to the multi-sensor arrangement described above and shown in FIG. 2, the outer housing aperture(s) 220 in the outer housing 202 correspond with the housing structure aperture(s) 110 shown in FIG. 1 and discussed above, i.e., housing apertures that connect the first space S1 with the second space S2.

Control circuitry 106 may include circuitry to receive (a) first sensor data 120 from first temperature sensor device 114 indicating T_{S1} in the external environment 214 (first space S1) and (a) second sensor data 122 from second temperature sensor device 116 indicating T_{S2} in the outer chamber (second space S2), and monitor a temperature difference ΔT_{S1/S2} between the first space S1 and second space S2 based on the first sensor data 120 and second sensor data 122. Control circuitry 106 may further include circuitry identify an alert condition, e.g., indicating a blockage BL of airflow AF through outer housing aperture(s) 220, based on the monitored temperature difference ΔT_{S1/S2}, and output an alert notification 130 in response to identifying the alert condition. For example, control circuitry 106 may output an alert notification 130 via a speaker 240, which alert notification 130 may include audible sounds or spoken text describing or indicating the identified alert condition, e.g., a detected blockage of outer housing aperture(s) 220. As another example, control circuitry 106 may output an alert notification 130 using an LED 242 or other visual indicator. In addition, or alternatively, control circuitry 106 may communicate the alert notification 130 to a remote device, e.g., a device accessible to a landlord, building owner, or building manager or superintendent, such that the alert condition (e.g., airflow blockage) may be addressed.

FIG. 3 is a cross-sectional side view of an example hazard detection device 300 representing another example implementation of the hazard detection device 100 shown in FIG. 1 with a second example multi-sensor arrangement. The example hazard detection device 300 is generally similar to the example hazard detection device 200 discussed above, with like numbers referring to like parts, except the second temperature sensor device 116 is arranged inside the inner chamber 210 to measure a second space temperature ΔT_{S2} in the inner chamber 210 (second space S2).

According to this multi-sensor arrangement shown in FIG. 3, both outer housing aperture(s) 220 in the outer housing 202 and inner housing aperture(s) 224 in the inner housing 204 correspond with the housing structure aperture(s) 110 shown in FIG. 1 and discussed above, i.e., housing apertures that connect the first space S1 with the second space S2. In this implementation, control circuitry 106 may monitor a temperature difference ΔT_{S1/S2} between the external environment 214 (first space S1) and the inner chamber 210 (second space S2) based on the first sensor data 120 and second sensor data 122, and identify an alert condition, e.g., indicating a blockage BL of airflow AF through outer housing aperture(s) 220 and/or inner housing aperture(s) 224, based on the monitored temperature difference ΔT_{S1/S2}, and output a corresponding alert notification 130, e.g., as discussed above.

FIG. 4 is a cross-sectional side view of an example hazard detection device 400 representing another example implementation of the hazard detection device 100 shown in FIG. 1 with a third example multi-sensor arrangement. The example hazard detection device 400 is generally similar to the example hazard detection devices 200 and 300 discussed above, with like numbers referring to like parts, except the first temperature sensor device 114 is arranged inside the outer housing 202 to measure a first space temperature ΔT_{S1} in the outer chamber 212 (first space S1), and the second temperature sensor device 116 is arranged inside the inner chamber 210 to measure a second space temperature ΔT_{S2} in the inner chamber 210 (second space S2).

According to this multi-sensor arrangement shown in FIG. 4, inner housing aperture(s) 224 in the inner housing 204 correspond with the housing structure aperture(s) 110 shown in FIG. 1 and discussed above, i.e., housing apertures that connect the first space S1 with the second space S2. In this implementation, control circuitry 106 may monitor a temperature difference ΔT_{S1/S2} between the outer chamber 212 (first space S1) and the inner chamber 210 (second space S2) based on the first sensor data 120 and second sensor data 122, and identify an alert condition, e.g., indicating a blockage BL of airflow AF through inner housing aperture(s) 224, based on the monitored temperature difference ΔT_{S1/S2}, and output a corresponding alert notification 130, e.g., as discussed above.

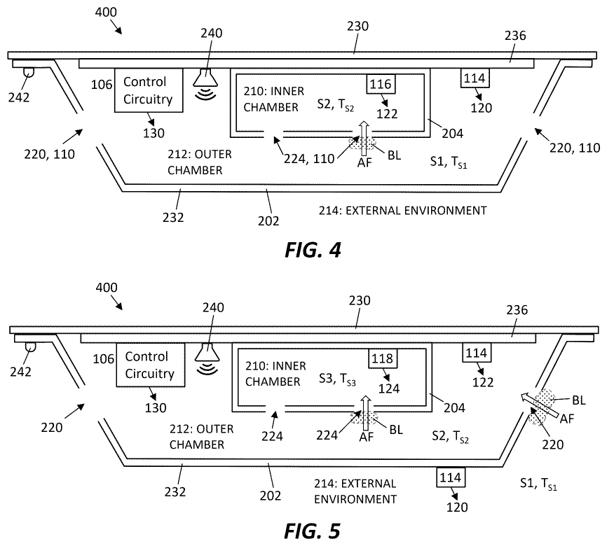

FIG. 5 is a cross-sectional side view of an example hazard detection device 500 representing another example implementation of the hazard detection device 100 shown in FIG. 1 with a fourth example multi-sensor arrangement. The example hazard detection device 500 is generally similar to the example hazard detection devices 200, 300, and 400 discussed above, with like numbers referring to like parts. However, hazard detection device 500 includes at least (a) a first temperature sensor device 114 arranged inside the inner housing 204 to generate first sensor data 120 indicating a first space temperature ΔT_{S1} in the inner chamber 210 (first space S1), (b) a second temperature sensor device 116 arranged inside the outer housing 202 to generate second sensor data 122 indicating a second space temperature ΔT_{S2} in the outer chamber 212 (second space S2), and (c) a third temperature sensor device 118 arranged inside the inner chamber 210 to generate third sensor data 124 indicating a third space temperature ΔT_{S3} in the inner chamber 210 (third space S3).

In this implementation, control circuitry 106 may monitor (a) a first temperature difference ΔT_{S1/S2} between the external environment 214 (first space S1) and outer chamber 212 (second space S2) based on first sensor data 120 from first temperature sensor device 114 and second sensor data 122 from second temperature sensor device 116, and (b) a second temperature difference ΔT_{S2/S3} between the outer chamber 212 (second space S2) and inner chamber 210 (third space S3) based on second sensor data 122 from second temperature sensor device 116 and third sensor data 124 from third temperature sensor device 118. Control circuitry 106 may identify alert conditions, e.g., indicating a blockage BL of airflow AF through outer housing aperture(s) 220 and/or inner housing aperture(s) 224, based on the monitored first temperature difference ΔT_{S1/S2} and or second temperature difference ΔT_{S2/S3}, and output corresponding alert notifications 130, e.g., as discussed above.

FIGS. 6A and 6B show an example hazard detection device 600 representing an example implementation of the hazard detection device 100 shown in FIG. 1, wherein the inner chamber 210 is a photo detection chamber for optical detection of smoke. FIG. 6A is a cross-sectional side view of the hazard detection device 600, while FIG. 6B is a bottom view of the photo detection chamber 210 and associated elements.

As shown, the photo chamber 210 may include a series of anti-reflective baffles 610, an infrared LED 612, and a photo diode 614 to detect radiation from the LED 612. Adjacent anti-reflective baffles 610 are separated from each other by respective gaps 618 that define inner housing apertures 224 allowing airflow into the photo chamber 210. Thus, the hazard detection device 600 defines an airflow AF between the external environment 214 and the photo chamber 210 passing through outer housing aperture(s) 220 in the outer housing 220 and inner housing apertures 224 (including gaps 618 between anti-reflective baffles 610).

The example hazard detection device 600 includes a first temperature sensor device 114 arranged outside the outer housing 202 to generate first sensor data 120 indicating a first space temperate ΔT_{S1} in the external environment 214 (first space S1), and a second temperature sensor device 116 arranged in the photo chamber 210 to generate second sensor data 122 indicating a second space temperature ΔT_{S2} in the photo chamber 210 (second space S2), which corresponds with the multi-sensor arrangement shown in FIG. 3 discussed above.

Control circuitry 106 may monitor a temperature difference ΔT_{S1/S2} between the external environment 214 (first space S1) and the photo chamber 210 (second space S2) based on the first sensor data 120 and second sensor data 122, and identify an alert condition based on the monitored temperature difference ΔT_{S1/S2}, and output a corresponding alert notification 130, e.g., as discussed above. The alert condition may indicate a blockage BL of airflow AF through outer housing aperture(s) 220 and/or inner housing apertures 224 (including gaps 618 between anti-reflective baffles 610).

Some examples may include a heater 620 (e.g., a resistor) to intentionally create a dynamic temperature event to test the operation of the alert condition detection function (i.e., blockage detection function) at defined periodic times or in response to a triggering event, for example in response to control circuitry 130 detecting actuation of a test button or receiving a test instruction from a remote device by wireless communication.

As discussed above, the temperature sensor devices disclosed herein, including the first and second temperature sensor devices 114 and 116 (as well as the third temperature sensor device 118 in the example implementation shown in FIG. 5) may comprise any type or types of temperature sensors, for example, thermocouples, diode, or silicon temperature sensors that generate sensor signals, e.g., voltages or other signals, corresponding with measured temperatures.

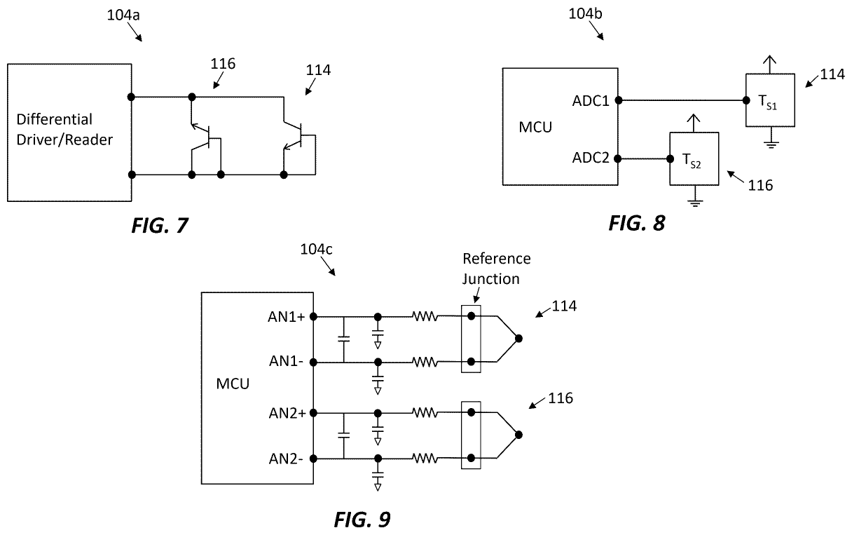

FIGS. 7-9 show example implementations of temperature sense circuitry 104 including first and second temperature sensor devices 114 and 116 for use in any of the example implementations disclosed herein.

First, FIG. 7 shows example temperature sense circuitry 104a including temperature sensor devices 114 and 116 embodied as a pair of anti-parallel diodes (e.g., PN junction transistors).

Second, FIG. 8 shows example temperature sense circuitry 104b including temperature sensor devices 114 and 116 embodied as a pair of silicon temperature sensors.

Third, FIG. 9 shows example temperature sense circuitry 104c including temperature sensor devices 114 and 116 embodied as a pair of thermocouples. It should be understood that other temperature sense devices and other circuitry may be used in other implementations.

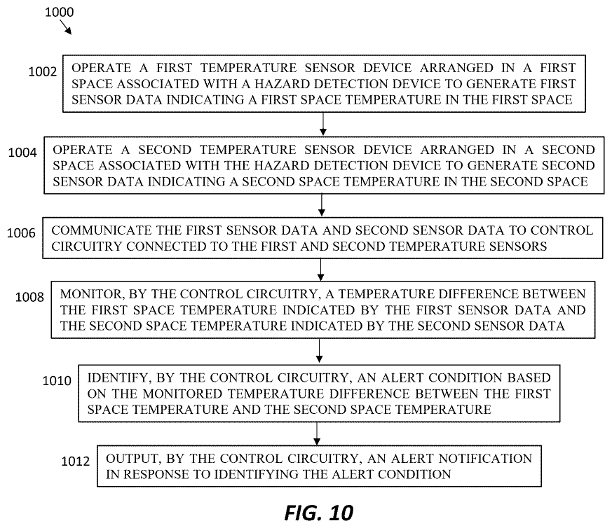

FIG. 10 is a flowchart 1000 showing a method for identifying an alert condition, e.g., a blocked airflow path, in a hazard detection device by monitoring a temperature difference at different locations. At 1002, a first temperature sensor device arranged in a first space S1 associated with a hazard detection device generates first sensor data indicating a first space temperature T_{S1} in the first space S1. At 1004, a second temperature sensor device arranged in a second space S2 associated with the hazard detection device generates second sensor data indicating a second space temperature T_{S2} in the second space S2. In some examples, the first space S1 and second space S2 are separated by a housing structure of the hazard detection device (e.g., an outer cover or an inner housing of the hazard detection device), wherein the housing structure includes at least one housing structure aperture allowing airflow between the first space S1 and second space S2.

At 1006, the first sensor data generated by the first temperature sensor device and second sensor data generated by the second temperature sensor device are communicated to control circuitry connected to the first and second temperature sensors. At 1008, the control circuitry monitors a temperature difference ΔT_{S1/S2} between the first space temperature T_{S1} indicated by the first sensor data and the second space temperature T_{S2} indicated by the second sensor data, based on the first and second sensor data. At 1010, the control circuitry identifies an alert condition based on the monitored temperature difference ΔT_{S1/S2}. At 1012, the control circuitry outputs an alert notification in response to identifying the alert condition, which alert notification may be output via a speaker or visual indicator (e.g., LED) and/or communicated to a remote device to notify a remote user.

1. A hazard detection device, comprising:
a housing structure separating a first space from a second space, the housing structure including at least one housing structure aperture allowing airflow between the first space and the second space;
temperature sense circuitry including:
a first temperature sensor device arranged in the first space to generate first sensor data indicating a first space temperature in the first space; and
a second temperature sensor device arranged in the second space to generate second sensor data indicating a second space temperature in the second space; and
control circuitry connected to the temperature sense circuitry, the control circuitry including circuitry to:
receive the first sensor data from the first temperature sensor device and the second sensor data from the second temperature sensor device;
monitor a temperature difference between the first space temperature indicated by the first sensor data and the second space temperature indicated by the second sensor data;
identify an alert condition based on the monitored temperature difference between the first space temperature and the second space temperature; and
output an alert notification in response to identifying the alert condition.

2. The hazard detection device of claim 1, wherein the control circuitry to identify the alert condition comprises the control circuitry to identify a blockage of the at least one housing structure aperture based on the monitored temperature difference between the first space temperature and the second space temperature.

3. The hazard detection device of claim 1, comprising:
an inner housing comprising the housing structure, wherein the at least one housing structure aperture comprises at least one aperture in the inner housing;
an inner chamber inside the inner housing;
an outer housing at least partially covering the inner housing; and
an outer chamber between the inner housing and the outer housing;
wherein the first temperature sensor device is arranged outside the outer housing, wherein the first space temperature indicated by the first sensor data is a temperature of an external environment outside the outer housing; and
wherein the second temperature sensor device is arranged in the inner chamber, wherein the second space temperature indicated by the second sensor data is a temperature in the inner chamber.

4. The hazard detection device of claim 3, wherein the inner chamber comprises a hazard detection chamber including hazard detection electronics for detecting at least one of smoke, fire, or carbon monoxide.

5. The hazard detection device of claim 1, comprising:
an inner housing comprising the housing structure, wherein the at least one housing structure aperture comprises at least one aperture in the inner housing;
an inner chamber inside the inner housing;
an outer housing at least partially covering the inner housing; and
an outer chamber between the inner housing and the outer housing;
wherein the first temperature sensor device is arranged in the outer chamber, wherein the first space temperature indicated by the first sensor data is a temperature in the outer chamber; and
wherein the second temperature sensor device is arranged in the inner chamber, wherein the second space temperature indicated by the second sensor data is a temperature in the inner chamber.

6. The hazard detection device of claim 1, comprising:
an inner housing;
an inner chamber inside the inner housing;
an outer housing at least partially covering the inner housing, the outer housing comprising the housing structure, wherein the at least one housing structure aperture comprises at least one aperture in the outer housing; and
an outer chamber between the inner housing and the outer housing;
wherein the first temperature sensor device is arranged outside the outer housing, wherein the first space temperature indicated by the first sensor data is a temperature of an external environment outside the outer housing; and
wherein the second temperature sensor device is arranged in the outer chamber, wherein the second space temperature indicated by the second sensor data is a temperature in the outer chamber.

7. The hazard detection device of claim 1, comprising:
an inner housing;
an inner chamber inside the inner housing;
an outer housing at least partially covering the inner housing, the outer housing comprising the housing structure, wherein the at least one housing structure aperture comprises at least one aperture in the outer housing; and
an outer chamber between the inner housing and the outer housing;
wherein the first temperature sensor device is arranged outside the outer housing, wherein the first space temperature indicated by the first sensor data is a temperature of an external environment outside the outer housing; and
wherein the second temperature sensor device is arranged in the inner chamber, wherein the second space temperature indicated by the second sensor data is a temperature in the inner chamber.

8. The hazard detection device of claim 1, comprising:
an inner housing;
an inner chamber inside the inner housing;
an outer housing at least partially covering the inner housing; and
an outer chamber between the inner housing and the outer housing;
wherein the first temperature sensor device is arranged outside the outer housing, wherein the first space temperature indicated by the first sensor data is a temperature of an external environment outside the outer housing;
wherein the second temperature sensor device is arranged in the outer chamber, wherein the second space temperature indicated by the second sensor data is a temperature in the outer chamber; and
a third temperature sensor device arranged in the inner chamber to generate third sensor data indicating a third space temperature in the inner chamber;
wherein the control circuitry comprises circuitry to:
monitor the temperature difference between the first space temperature indicated by the first sensor data and the second space temperature indicated by the second sensor data;
monitor a further temperature difference between the second space temperature indicated by the second sensor data and the third space temperature indicated by the third sensor data; and
identify an alert condition based on at least one of the monitored temperature difference or the monitored further temperature difference.

9. The hazard detection device of claim 1, wherein the control circuitry to identify an alert condition based on the monitored temperature difference between the first space temperature and the second space temperature comprises control circuitry to:
compare the temperature difference between the first space temperature and the second space temperature to a temperature difference threshold value; and
determine an alert condition if the temperature difference exceeds the temperature difference threshold value.

10. The hazard detection device of claim 1, wherein the control circuitry to identify the alert condition based on the monitored temperature difference between the first space temperature and the second space temperature comprises control circuitry to:
compare the temperature difference between the first space temperature and the second space temperature to a temperature difference threshold value; and
determine an alert condition if the temperature difference exceeds the temperature difference threshold value for a defined duration of time.

11. The hazard detection device of claim 1, wherein the control circuitry to identify the alert condition based on the monitored temperature difference between the first space temperature and the second space temperature comprises control circuitry to:
determine a rate of change of the temperature difference between the first space temperature and the second space temperature; and
determine an alert condition based on the determined rate of change of the temperature difference between the first space temperature and the second space temperature.

12. The hazard detection device of claim 1, wherein determining the alert condition based on the determined rate of change of the temperature difference between the first space temperature and the second space temperature comprises determining the alert condition if the determined rate of change of the temperature difference between the first space temperature and the second space temperature is less than a temperature difference rate-of-change threshold value.

13. A method, comprising:
operating a first temperature sensor device arranged in a first space associated with a hazard detection device to generate first sensor data indicating a first space temperature in the first space;
operating a second temperature sensor device arranged in the second space associated with the hazard detection device to generate second sensor data indicating a second space temperature in the second space;
wherein the first space and second space are separated by a housing structure of the hazard detection device, the housing structure including at least one housing structure aperture allowing airflow between the first space and the second space;
receiving, at control circuitry connected to the first and second temperature sensors, the first sensor data from the first temperature sensor device and the second sensor data from the second temperature sensor device;
monitoring, by the control circuitry, a temperature difference between the first space temperature indicated by the first sensor data and the second space temperature indicated by the second sensor data;
identifying, by the control circuitry, an alert condition based on the monitored temperature difference between the first space temperature and the second space temperature; and
outputting, by the control circuitry, an alert notification in response to identifying the alert condition.

14. The method of claim 13, wherein:
the housing structure comprises a structure of an inner housing of the hazard detection device;
the first temperature sensor device is arranged in an outer chamber between the inner housing and an outer housing of the hazard detection device, wherein the first space temperature indicated by the first sensor data is a temperature in the outer chamber; and
the second temperature sensor device is arranged in an inner chamber inside the inner housing, wherein the second space temperature indicated by the second sensor data is a temperature in the inner chamber.

15. The method of claim 13, wherein:
the housing structure comprises a structure of an outer housing of the hazard detection device;
the first temperature sensor device is arranged outside the outer housing, wherein the first space temperature indicated by the first sensor data is a temperature of an external environment outside the outer housing; and
the second temperature sensor device is arranged inside the outer housing, wherein the second space temperature indicated by the second sensor data is a temperature inside the outer housing.

16. The method of claim 13, wherein identifying the alert condition comprises identifying a blockage of the at least one housing structure aperture based on the monitored temperature difference between the first space temperature and the second space temperature.

17. The method of claim 13, wherein identifying the alert condition comprises:
comparing the temperature difference between the first space temperature and the second space temperature to a temperature difference threshold value; and
identifying the alert condition if the temperature difference exceeds the temperature difference threshold value.

18. The method of claim 13, wherein identifying an alert condition comprises:
comparing the temperature difference between the first space temperature and the second space temperature to a temperature difference threshold value; and
identifying an alert condition if the temperature difference exceeds the temperature difference threshold value for a defined duration of time.

19. The method of claim 13, wherein identifying the alert condition comprises:
determining a rate of change of the temperature difference between the first space temperature and the second space temperature; and
identifying the alert condition based on the determined rate of change of the temperature difference between the first space temperature and the second space temperature.

20. A system, comprising:
a processor; and
logic instructions stored in non-transitory memory and executable by the processor to:
receive first sensor data from a first temperature sensor device arranged in a first space associated with a hazard detection device, the first sensor data indicating a first space temperature in the first space;
receive second sensor data from a second temperature sensor device arranged in a second space associated with the hazard detection device, the second sensor data indicating a second space temperature in the second space;
wherein the first space and second space are separated by a housing structure of the hazard detection device, the housing structure including at least one housing structure aperture allowing airflow between the first space and the second space;
monitor a temperature difference between the first space temperature indicated by the first sensor data and the second space temperature indicated by the second sensor data;
identify an alert condition based on the monitored temperature difference between the first space temperature and the second space temperature; and
output an alert notification in response to identifying the alert condition.
